(19) United States
(12) Patent Application Publication
(10) Pub. No.: US 2012/0195234 A1
(43) Pub. Date: Aug. 2, 2012

(54) METHOD FOR POLICY-BASED CONTROL OF ENTERPRISE MESSAGING

(76) Inventors: Yigang Cai, Naperville, IL (US); Suzann Hua, Lisle, IL (US)

(21) Appl. No.: 13/017,392

(22) Filed: Jan. 31, 2011

(51) Int. Cl. H04L 12/16

(52) U.S. Cl. 370/259

(57) ABSTRACT

The present invention provides a method for routing calls within an organization. One embodiment of the method includes detecting, at a server, a message transmitted by a calling party to one or more called parties. The calling party and the called parties are members of the organization. The method also includes determining, at the server, one or more relationships between the calling party and the called parties using information stored in a database associated with the organization. The method further includes routing the message using one or more policies associated with the determined relationship.

### BACKGROUND OF THE INVENTION

1. Field of the Invention

This invention relates generally to communication systems, and, more particularly, to message control in communication systems.

2. Description of the Related Art

Modern communication systems allow practically everybody to communicate with each other as long as one party knows the other party's e-mail address, phone number, instant messaging handle, or other user identifier. However, easy communication also has a number of drawbacks. For example, many parents are well acquainted with the high text messaging bills that can be incurred by a teenager. For another example, prominent people carefully guard their personal e-mail addresses and phone numbers to prevent overwhelming floods of messages. Conventional message usage control can be applied on a per-user-equipment basis. For example, parents can apply message usage control to their children's cell phones and/or e-mail accounts. However, applying message usage control on a per-user-equipment basis becomes unwieldy and impractical as the number of user equipment grows.

### SUMMARY OF EMBODIMENTS OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for routing calls within an organization. One embodiment of the method includes detecting, at a server, a message transmitted by a calling party to one or more called parties. The calling party and the called parties are members of the organization. The method also includes determining, at the server, one or more relationships between the calling party and the called parties using information stored in a database associated with the organization. The method further includes routing the message using one or more policies associated with the determined relationship.

In another embodiment, a method is provided for routing calls between employees of an organization. One embodiment of the method includes routing, at a server, a message transmitted by a calling party to one or more called parties. The calling party and each called party are employees of an organization and the routing is determined based upon positions of the calling party and the called party in a structure of the organization.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a first exemplary embodiment of a communication

FIG. 2 conceptually illustrates one embodiment of an employee hierarchy and a set of communication policies for employees within the employee hierarchy;

FIG. 3 conceptually illustrates a first exemplary embodiment of a call flow;

FIG. 4 conceptually illustrates a second exemplary embodiment of a call flow; and

FIG. 5 conceptually illustrates a third exemplary embodiment of a call flow.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally speaking, the present application describes embodiments of techniques that are used to facilitate communication between employees or other members of an organization. As used herein, the term “organization” will be understood to refer to a company, an enterprise, an affiliate, a subsidiary, a foundation, a government agency, a non-governmental organization, a university, a school, or any other group of people that participate in a social arrangement that pursues collective goals, controls its own performance, and has a boundary separating it from its environment. Conventional communication systems provide message and/or call routing control on a per-user equipment basis. For example, an organization can establish rules or policies for routing messages to and from user equipment that is allocated to users (e.g., employees) by the organization. However, conventional communication systems do not support message routing/control based on the structure of the organization.

The present application therefore describes a communication system that supports message routing of both data and voice communication based on policies and/or rules that reflect the organizational structure. For example, intra-organization messages between calling and called parties can be detected by a server that can route the message between the calling party and one or more called parties (e.g., for one-to-one messaging or one-to-many broadcasting). The server can determine the routing based on a relationship between the calling and called parties. The relationship (and in some cases the policies or rules for routing calls between parties that share the relationship) can be stored in an information technology (IT) or human resources (HR) database associated with the organization. For example, the server can route the call based on the relative positions of the calling and called parties in an employee hierarchy of the organization.

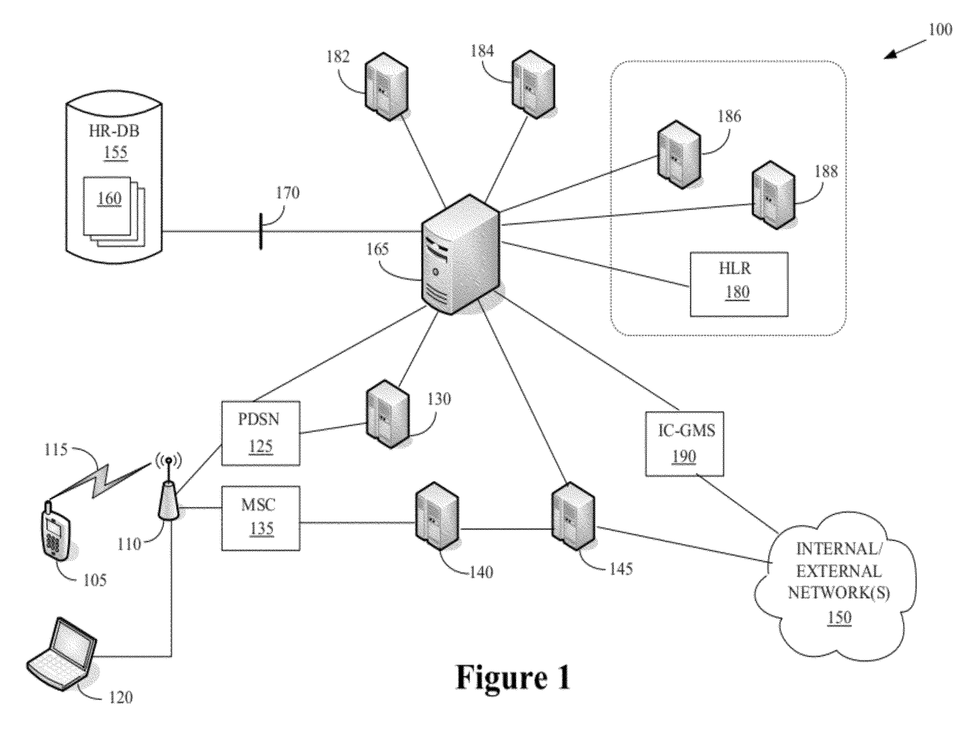

FIG. 1 conceptually illustrates a first exemplary embodiment of a communication system 100. In the illustrated embodiment, the communication system 100 is used to facilitate communication between employees or other members of an organization. Users can access the communication system 100 wirelessly using mobile units or other wireless-enabled user equipment 105 that communicate with base stations, access points, or access networks 110 over an air interface 115. Users may alternatively access the communication system 100 using a wireline connection between user equipment 120 and the access network 110. In the interest of clarity, the communication system 100 supports wired and wireless access via a single access network 110. However, persons of ordinary skill in the art having benefit of the present disclosure should appreciate that in alternative embodiments other base stations, access points, access networks, or other interfaces can be used to support wireless access, wired access, or any combination thereof. Persons of ordinary skill in the art having benefit of the present disclosure should also appreciate that the communication system 100 may operate according to any wired and/or wireless standards and/or protocols such as the standards and/or protocols established by the Third Generation Partnership Project (3GPP, 3GPP2), the Telecommunications and Internet-converged Services and Protocols for Advanced Networking (TISPAN) standards body, and the like.

The access network 110 may be electronically and/or communicatively coupled to a packet data serving node (PDSN) 125, which acts as a connection point between the radio access networks and the Internet protocol (IP) networks in the communication system 100. The PDSN 125 may be electronically and/or communicatively coupled to a mobility management server (MMS) 130 that supports mobility of user equipment throughout the communication system 100 and roaming into other networks and/or systems. The access network 110 may also be electronically and/or communicatively coupled to a mobile switching center (MSC) 135 that is used to route calls to other subscribers in the communication system 100. For example, in the illustrated embodiment, the MSC 135 is electronically and/or communicatively coupled to a short message service center (SMSC) 140 that supports delivery of short messages and a short message peer-to-peer gateway (SMPP-GW) 145 that supports the protocols for delivery of short messages. These entities can be used to convey messages to the organization's internal network and/or to an external network, which are collectively represented as the cloud 150.

A database 155, such as an IT database and/or a human resources (HR) database, is used to store profiles 160 for users/employees/members/subscribers of the organization. The profiles 160 may include information including a unique identifier (such as an employee ID number) and other contact information such as phone numbers, e-mail addresses, instant messaging handles, and the like. The database 155 also includes information indicating and/or defining relationships between organization members and/or groups of members. For example, in a hierarchical organization, the database 155 may include information indicating the relative positions of members or groups of members within the organization hierarchy. For another example, in a matrix type organization, the database 155 may include information indicating the positions of members and/or groups of members (and interconnections between the members and/or groups) within the organization matrix. In various embodiments, the database 155 can be implemented within the communication system 100 (as shown) or implemented externally, e.g., by a third-party. In one embodiment, the database 155 may also include information that specifies policies and/or rules that are used to control routing of messages within the communication system 100. However, in alternative embodiments, the policy/rule information may be stored at other locations or in other databases, e.g., by a third-party.

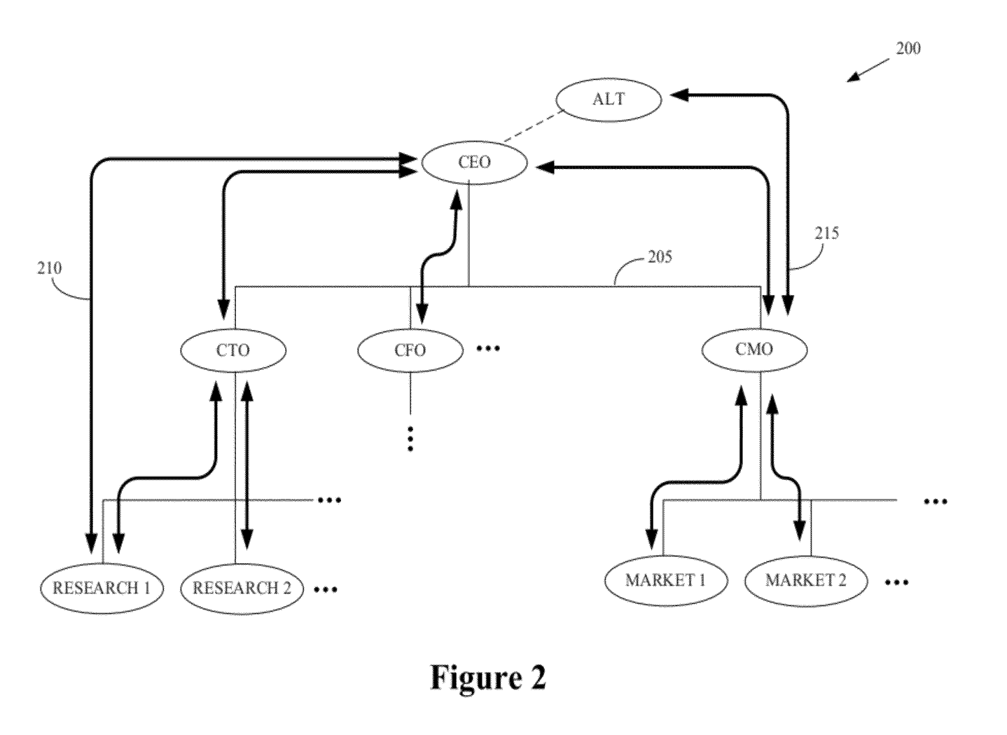

FIG. 2 conceptually illustrates one embodiment of an employee hierarchy 200 and a set of communication policies for employees within the employee hierarchy 200. In the illustrated embodiment, the hierarchical relationships between employees and/or groups are indicated by the branches of the tree 205. For example, the CEO of the organization is at the top of the hierarchy 200 and employees at the next level of the tree 205 (e.g., the chief technology officer (CTO), the chief financial officer (CFO), and the chief marketing officer (CMO)) report directly to the CEO. The relationships between these employees and the employees/groups at lower levels in the hierarchy are indicated by additional branches in the tree 205. For example, one or more research groups (e.g., Research-1, Research-2, etc) may report to the CTO and one or more marketing groups (e.g., Market-1, Market-2) may report to the CMO. In the illustrated embodiment, the CEO is also associated with at least one alternate entity (ALT), as indicated by the dashed line. The alternate entity may be an assistant, a secretary, another communication device such as a personal smart phone or home computer, and the like.

Exemplary communication policies in FIG. 2 are represented by the boldfaced double headed arrows, which indicate allowed communication pathways within the organization hierarchy 200. In the illustrated embodiment, a database may store policies that indicate that communication is permitted between employees/groups in adjacent levels of the tree 205. For example, the CEO may always be permitted to exchange messages with the CTO, CFO, CMO, and other employees/groups at that level of the hierarchy. Similarly, the research groups (or a representative thereof) may always be permitted to exchange messages with the CTO and the marketing groups (or a representative thereof) may always be permitted to exchange messages with the CMO. Additional rules and/or policies may be specified to allow specific employees/groups to communicate with each other. For example, if the Research-1 group is doing research that is of particular interest to the CEO, then a policy may be established to allow messages to be exchanged between the CEO and the Research-1 group (as indicated by arrow 210).

Policies and/or rules may also be established to redirect messages to a different destination and/or to copy messages intended for one called party to another called party so that the other called party also receives the message. For example, a policy may be established that allows messages exchanged by the CEO and the CMO to be copied and/or redirected to the alternate entity (ALT) associated with the CEO (as indicated by the arrow 215). Broadcast messages may also be controlled based upon the policies and/or rules. For example, the CEO and the alternate entity may always be allowed to broadcast messages to the entire organization. However, other employees/groups may only be allowed to broadcast messages to employees/groups that are at lower levels in the tree 205. For example, the CTO may only be allowed to broadcast messages to the research groups and the CMO may only be allowed to broadcast messages to the marketing groups. The CTO may not be allowed to broadcast messages to the marketing groups and the CMO may not be allowed to broadcast messages to the research groups.

Additional conditions may also be applied to each policy and/or rule. In one embodiment, different policies and/or rules may be applied at different times of the day. For example, the policies governing broadcast messages may be applied during business hours, but some or all broadcast messages may be disabled, blocked, or denied if they are sent outside of business hours. Message exchange with the alternate entities may also be time sensitive, e.g., message exchange with private destinations may be disabled or prevented outside of business hours. Initiation times, effective time periods, and/or expiration times can also be applied to the policies and/or rules. In other embodiments, different policies and/or rules may be applied depending on the location of the called party and/or the calling party. For example, if the CEO is traveling, then communication with the CEO may be disabled and all messages directed to the CEO may be redirected to the alternate entity. Similarly, employees/groups may redirect messages to alternate e-mail addresses, voicemail, cell phones, laptops, and the like when they are traveling. For yet another example, message content may be used to determine which policies and/or rules to apply when routing the message.

In various alternative embodiments, the policies and/or rules may be symmetric or asymmetric. For example, a symmetric policy may indicate that the CEO can send messages to the CTO and receive replies from the CTO, and the CTO may also send messages to the CEO and receive replies from the CEO. Symmetric policies can also be applied based on the relative positions of the calling party and the called party in the hierarchy, e.g., whether or not employees can exchange messages directly may be determined by the number of hierarchy levels between the employees. For another example, an asymmetric policy may indicate that the CEO can send messages to individuals or groups at any level in the hierarchy but only the top two hierarchy levels may reply to the CEO directly. Individuals or groups at hierarchy levels below the top two hierarchy levels may not be able to send messages to the CEO but these individuals or groups may be permitted to reply to a message sent by the CEO. In one embodiment, the replies from individuals or groups at hierarchy levels below the top two hierarchy levels may be directed to the CEO's assistant or secretary. In some cases, individuals or groups at even lower levels (e.g., six or more levels below the calling party in the hierarchy) may not be permitted to reply to messages sent by the higher-level calling party.

Referring back to FIG. 1, a server 165 is implemented in the communication system 100 and configured to detect intra-organization messages (e.g., messages between members or employees of the organization) and then route the messages based on the organizational relationships of the called and calling parties. In one embodiment, intra-organization messages can be detected based on the origination and destination addresses or identifiers included in the messages. The server 165 may therefore be referred to as a message control server, an enterprise messaging usage control server, and enterprise usage control server, and the like. In the illustrated embodiment, messages sent or received within the organization pass through the server 165 so that the server 165 can determine how to route the messages. For example, the server 165 can be configured to route messages to one destination or called party within the organization, multiple destinations or called parties within the organization, and/or alternative destinations (which may or may not be within the organization) based on the information stored in a database such as an organizational HR database 160.

The server 165 therefore supports a data query interface 175 to the organizational HR database 155. In the illustrated embodiment, the data query interface 175 operates according to the Lightweight Directory Access Protocol (LDAP), which is an application protocol for reading and editing directories over an IP network. A directory is defined as an organized set of records, such as the subscriber/user profiles 160 stored in the database 155: For example, the database 155 may include a directory that includes an alphabetical list of persons and organizations and their associated address, email address, phone number, and or other identifier. A directory of hierarchical information can be represented a tree of directory entries. An entry consists of a set of attributes. An attribute has a name (an attribute type or attribute description) and one or more values. Each entry has a unique identifier. A client (in this case the server 165) may start an LDAP session by connecting to an LDAP server (not shown in FIG. 1). The client then sends an operation request to the server and the server sends responses in return. Exemplary operations that can be performed by the client include starting a secure connection, authenticating and specifying an LDAP protocol version, searching for and/or retrieving directory entries, testing whether a named entry contains a given attribute value, adding a new entry, deleting an entry, modifying an entry, moving or renaming an entry, aborting a previous request, and closing the connection. Authorized personnel can therefore configure and/or modify the database 155 by sending requests to the server 165 to perform the requested modification via the interface 170.

The server 165 can also communicate with other entities in the communication system 100. For example, the server 165 may communicate with a home location register (HLR) 180, which is a central database that contains details of each mobile phone subscriber that is authorized to use the network. The server 165 communicates with the home location register 180 to validate users/subscribers to ensure that they are authorized to use the communication system 100. If a particular user is not authorized, then the server 165 can deny or reject messages using the information stored in the home location register 180. The server 165 can also communicate with a mobile application part (MAP) server 182 that provides application layer services according to the SS7 protocols, an ENUM server 184 for mapping telephone numbers to a Uniform Resource Identifier (URI) that can be used to contact a resource associated with that number, a charging entity 186 for determining online/off-line charges associated with the message, and an application server 188 for providing various applications. The server 165 may also communicate with an IC-GMS 190 that communicates with the networks 150.

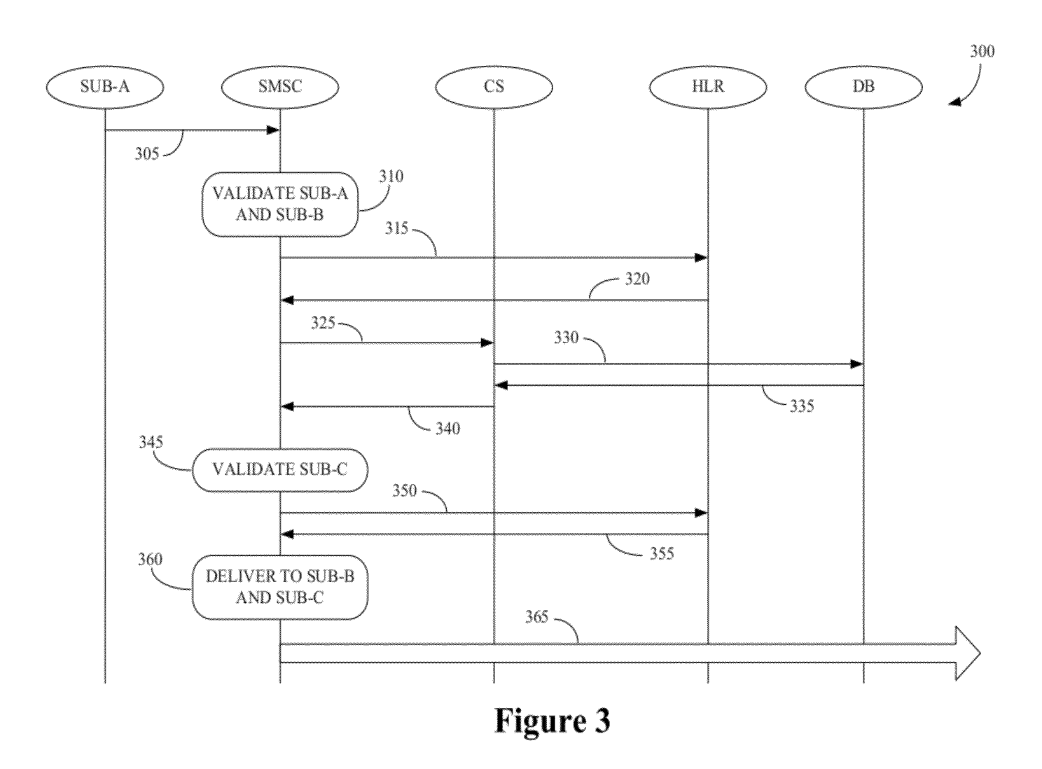

FIG. 3 conceptually illustrates a first exemplary embodiment of a call flow 300. In the illustrated embodiment, a first member (SUB-A) of an organization transmits (at 305) a message request to a short message service center (SMSC). The request is to transmit a short message service (SMS), enhanced message service (EMS), or multimedia message service (MMS) message from the first member to a second member (SUB-B). The request may therefore include information indicating the identity of the first and second members, as well as the content of the message. Although the call flow 300 is illustrated using SMS/EMS/MMS messages, persons of ordinary skill in the art having benefit of the present disclosure should appreciate that the call flow 300 is intended to be exemplary and alternative embodiments may be used to transmit other types of messages including e-mail messages, instant messages, packet or circuit switched voice calls, and the like. The SMSC validates (at 310) the first member and the second member. For example, the SMSC may confirm that the first member and the second member are subscribed to the messaging service and are authorized to transmit and/or receive messages by the messaging service.

Once the members have been validated, the SMSC transmits (at 315) a message request to a home location register (HLR). In one embodiment, the message request is an SMSREQ message that requests addressing information for the destination party or called party, e.g., the second member (SUB-B). The HLR may search its database using identifier providing the message request and, if it is able to locate the second member's information, the HLR returns (at 320) a response message indicating that the second member is registered. The response message may also include identifiers or other addressing information that allow the SMSC to identify the second member and to address messages to the second member.

In the illustrated embodiment, the SMSC is configured to operate in a system that uses organization-wide messaging control. The SMSC may therefore transmit (at 325) a query to a message control server (CS) to determine whether any policies or rules have been established to control transmission of messages between the two members before sending the message to the called party. For example, the SMSC may transmit (at 325) an LDAP query to the control server, which may then forward (at 330) the query to the appropriate database over an interface between the control server and the database. In response to the query, the database may be searched as described herein to determine whether any policies and/or rules should be applied to the requested message. For example, the database may be searched to determine the positions and/or relative positions of the calling party and the called party within the organizational hierarchy or other organizational structure. In the illustrated embodiment, a search of the database reveals that the current policy for the requested message is to permit transmission of the requested message and to transmit a copy of the requested message to another (third) organization member (SUB-C). The database therefore returns (at 335) a query response such as an LDAP response to the control server indicating that the requested transmission is allowed and requesting that the SMSC also transmit a copy of the message to the third member. The control server then forwards (at 340) a response to the SMSC.

Since the control server has requested that a copy be sent to the third member, the SMSC may validate (at 345) the third member to confirm that the third member is subscribed to the messaging service and is authorized to receive messages via the messaging service. Once the third member has been validated, the SMSC transmits (at 350) a message request to the home location register (HLR). In one embodiment, the message request is an SMSREQ message that requests addressing information for the destination party or called party, e.g., the third member (SUB-C). The HLR may search its database using identifier providing the message request and, if it is able to locate the third member's information, the HLR returns (at 355) a response message indicating that the third member is registered. The response message may also include identifiers or other addressing information that allow the SMSC to identify the third member and to address messages to the third member. The SMSC may then initiate (at 360) delivery of the messages to the second and third members and transmit (at 365) copies of the message to the second and third members.

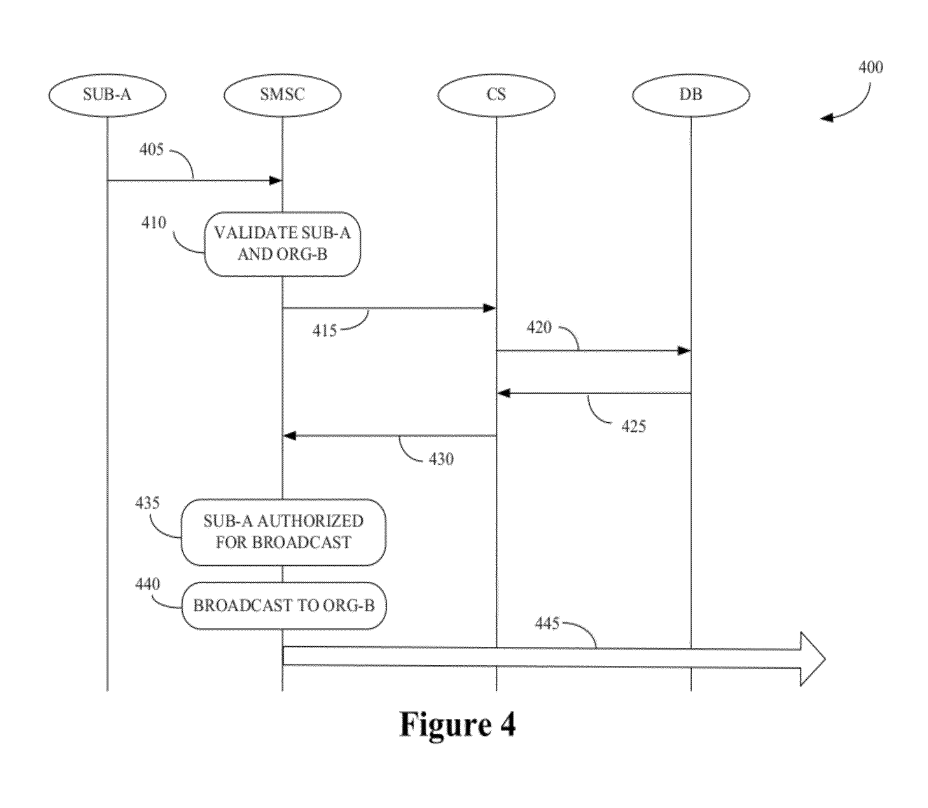

FIG. 4 conceptually illustrates a second exemplary embodiment of a call flow 400. In the illustrated embodiment, a first member (SUB-A) of an organization transmits (at 405) a message request to a short message service center (SMSC). The request is to broadcast a short message service (SMS), enhanced message service (EMS), or multimedia message service (MMS) message from the first member to an organization (ORG-B). The request may therefore include information indicating the identity of the first member and the organization, as well as the content of the message. In the illustrated embodiment, the organization may refer to an entire organization and all the employees/members therein, or it may alternatively refer to some portion or subset of the organization such as a division, a section, a group, selected individuals, or a combination thereof. Although the call flow 400 is illustrated using SMS/EMS/MMS messages, persons of ordinary skill in the art having benefit of the present disclosure should appreciate that the call flow 400 is intended to be exemplary and alternative embodiments may be used to broadcast other types of messages including e-mail messages, instant messages, voice calls, and the like.

In the illustrated embodiment, the SMSC validates (at 410) the first member and the organization. Once the member and the organization have been validated, the SMSC may communicate with a home location register (HLR), as in the first exemplary embodiment of the call flow 300. However, in the interest of clarity, this portion of the message flow 400 is not explicitly shown in FIG. 4. In the illustrated embodiment, the SMSC is configured to operate in a system that uses organization-wide messaging control and so the SMSC transmits (at 415) a query to a message control server (CS) to determine whether any policies or rules control broadcast of messages between from the first member to the organization before broadcasting the message. For example, the SMSC may transmit (at 415) an LDAP query to the control server, which may then forward (at 420) the query to the appropriate database over an interface between the control server and the database. In response to the query, the database may be searched as described herein to determine whether any policies and/or rules should be applied to the requested broadcast. For example, the database may be searched to determine the positions of the first member within the organizational hierarchy or other organizational structure. In the illustrated embodiment, a search of the database reveals that the current policy for the requested message is to permit broadcast of the requested message to the organization. The database therefore returns (at 425) a query response such as an LDAP response to the control server indicating that the requested broadcast is allowed. The control server then forwards (at 430) a response to the SMSC.

When the SMSC receives the response, it uses the information in the response to determine (at 435) that the first member is authorized to broadcast the message to the requested organization. The SMSC then initiates (at 440) broadcast of the message and the message is broadcast (at 445) to the organization.

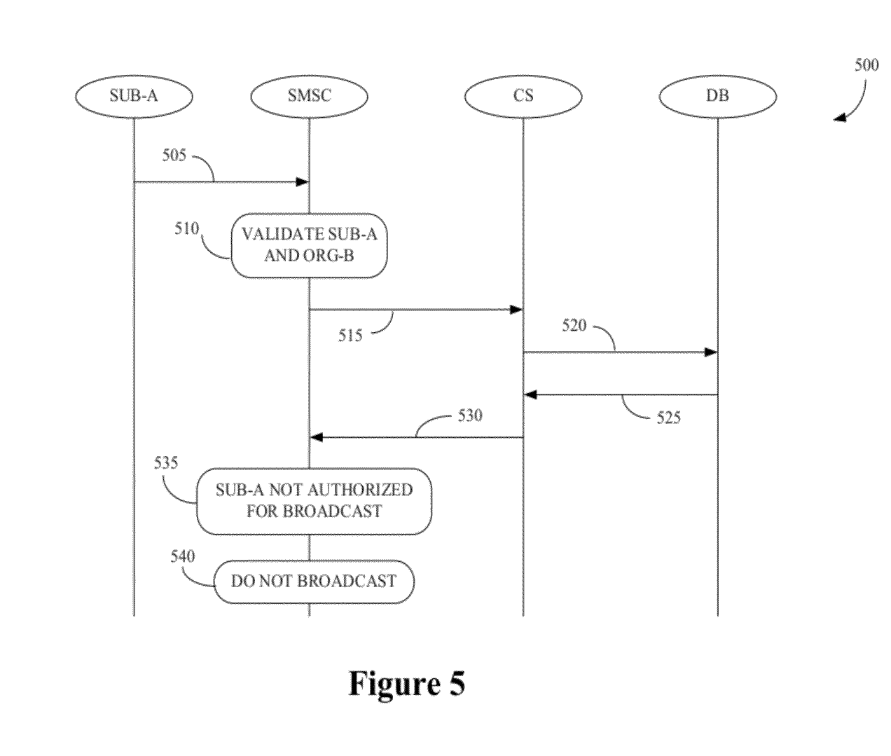

FIG. 5 conceptually illustrates a third exemplary embodiment of a call flow 500. In the illustrated embodiment, a first member (SUB-A) of an organization transmits (at 505) a message request to a short message service center (SMSC). The request is to broadcast a short message service (SMS), enhanced message service (EMS), or multimedia message service (MMS) message from the first member to an organization (ORG-B). The request may therefore include information indicating the identity of the first member and the organization, as well as the content of the message. As discussed herein, the organization may refer to an entire organization or a subset of the organization. Although the call flow 400 is illustrated using SMS/EMS/MMS messages, persons of ordinary skill in the art having benefit of the present disclosure should appreciate that the call flow 500 is intended to be exemplary and alternative embodiments may be used to broadcast other types of messages including e-mail messages, instant messages, voice calls, and the like.

In the illustrated embodiment, the SMSC validates (at 510) the first member and the organization. Once the member and the organization have been validated, the SMSC may communicate with a home location register (HLR), as in the first exemplary embodiment of the call flow 300. However, in the interest of clarity, this portion of the message flow 500 is not explicitly shown in FIG. 5. In the illustrated embodiment, the SMSC is configured to operate in a system that uses organization-wide messaging control and so the SMSC transmits (at 515) a query to a message control server (CS) to determine whether any policies or rules control broadcast of messages between from the first member to the organization before broadcasting the message. For example, the SMSC may transmit (at 515) an LDAP query to the control server, which may then forward (at 520) the query to the appropriate database over an interface between the control server and the database. In response to the query, the database may be searched as described herein to determine whether any policies and/or rules should be applied to the requested broadcast. In the illustrated embodiment, a search of the database reveals that the current policy for the requested message is to deny permission to broadcast the requested message to the organization. The database therefore returns (at 525) a query response such as an LDAP response to the control server indicating that the requested broadcast is denied. The control server then forwards (at 530) the response to the SMSC.

When the SMSC receives the response, it uses the information in the response to determine (at 535) that that the first member is not authorized to broadcast the message to the requested organization. The SMSC then aborts (at 540) broadcast of the message and the message is not broadcast to the organization. In the second and third exemplary embodiments, the SMSC uses the policies/rules in the response in a binary fashion, e.g., either the first member is allowed to broadcast a message to the entire requested organization or it is not allowed to broadcast the message at all. However, persons of ordinary skill in the art having benefit of the present disclosure should appreciate that alternative embodiments may allow the request and/or the broadcast to be modified based on the policies and/or rules that are applied to the request. For example, if the policies and/or rules indicate that the first member is only allowed to broadcast messages to a first subset of the organization and is not allowed to broadcast messages to a second (complementary) subset of the organization, then the SMSC made broadcast the message to the first subset and not to the second subset of the organization.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method of routing calls within an organization, comprising:
detecting, at a server, a message transmitted by a calling party to at least one called party, wherein the calling party and said at least one called party are members of the organization;
determining, at the server, at least one relationship between the calling party and said at least one called party using information stored in a database associated with the organization; and
routing the message using at least one policy associated with said at least one determined relationship.

2. The method of claim 1, wherein detecting the message comprises determining that an identifier of the calling party included in the message and at least one identifier of said at least one called party included in the message indicate that both the calling party and said at least one called party are members of the organization.

3. The method of claim 2, wherein detecting the message comprises querying the database using the identifier of the calling party and said at least one identifier of said at least one called party to determine whether the calling party and said at least one called party are members of the organization.

4. The method of claim 1, wherein said information stored in the database comprises profiles of the calling party and said at least one called party, and wherein routing the message comprises routing the message based upon information in at least one of the profiles of the calling party for said at least one called party.

5. The method of claim 4, wherein said information in the profiles indicates positions of the calling party and said at least one called party in an organization hierarchy.

6. The method of claim 5, wherein routing the message comprises transmitting the message to said at least one called party when said at least one policy indicates that the position of the calling party authorizes the calling party to send messages to said at least one called party.

7. The method of claim 5, wherein routing the message comprises denying a request to send the message to said at least one called party when said at least one policy indicates that the position of the calling party does not authorize the calling party to send messages to said at least one called party.

8. The method of claim 5, wherein determining said at least one relationship comprises querying the database to determine relative positions of the calling party and said at least one called party in the organization hierarchy.

9. The method of claim 8, wherein routing the message comprises routing the message using at least one policy for routing messages having the determined relative positions in the organization hierarchy.

10. The method of claim 9, wherein routing the message comprises sending the message to said at least one called party when said at least one policy permits transmission of messages between parties having the determined relative positions in the organization hierarchy.

11. The method of claim 9, wherein routing the message comprises sending the message to at least one alternate called party when said at least one policy permits redirecting a message from said at least one called party to said at least one alternate called party.

12. The method of claim 9, wherein routing the message comprises denying a request to send the message to said at least one called party when said at least one policy does not permit transmission of messages between parties having the determined relative positions in the organization hierarchy.

13. The method of claim 1, wherein routing the message using at least one policy that determines whether to send a message or deny the message based on at least one of a message destination, message content, or a transmission time of the message.

14. The method of claim 13, wherein routing the message comprises determining whether to route the message to at least one alternate called party based on said at least one of the message destination, the message content, or the transmission time of the message.

15. A method, comprising:
routing, at a server, a message transmitted by a calling party to at least one called party, wherein the calling party and said at least one called party are employees of an organization, wherein said routing is determined based upon positions of the calling party and said at least one called party in a structure of the organization.

16. The method of claim 15, comprising determining that the called party and said at least one calling party are employees of the organization when an identifier of the calling party included in the message and at least one identifier of said at least one called party included in the message indicate that both the calling party and said at least one called party are employees of the organization.

17. The method of claim 15, comprising determining the positions of the calling party and said at least one called party in an employee hierarchy by accessing a human resource database that includes information indicating that the structure of the organization is hierarchical and indicating the positions of employees in the employee hierarchy.

18. The method of claim 15, wherein routing the message comprises routing the message using at least one policy for routing messages between employees having the determined positions in the structure of the organization.

19. The method of claim 18, wherein routing the message comprises sending the message to at least one alternate called party when said at least one policy permits redirecting a message from said at least one called party to said at least one alternate called party.

20. The method of claim 19, wherein routing the message comprises denying a request to send the message to said at least one called party when said at least one policy does not permit transmission of messages between parties having the determined positions in the structure of the organization.
